(19) United States
(12) Patent Application Publication
(10) Pub. No.: US 2008/0311364 A1
(43) Pub. Date: Dec. 18, 2008

(54) Multi-layered self-adhesive protective film

(76) Inventor: Jose de Jesus Ortega Sanchez, Delegacion Alvaro Obregon DF (MX)

Correspondence Address: MICHAEL A. O'NEIL, P.C., 5949 SHERRY LANE, SUITE 820, DALLAS, TX, 75225, US

(21) Appl. No.: 11/894,493

(22) Filed: Aug. 21, 2007

(30) Foreign Application Priority Data
Jun. 15, 2007 (MX) MX/A/2007/007521

(51) Int. Cl. B32B 7/02; B32B 7/12

(52) U.S. Cl. 428/213; 428/220; 428/354

(57) ABSTRACT

The invention is a process for making a multi-layered self-adhesive, protective film consisting of a base layer made with a homopolymer or a copolymer of a polyolefin of type C2 or C3; a pressure sensitive adhesive layer of a copolymer of ethylene and vinyl acetate, in which the content of vinyl acetate is between 45% and 90%; and a tie layer which unites the other two layers into a multi-layer, auto-adhesive protective film. The tie layer is formed by a polyolefin or a copolymer made from ethylene and vinyl acetate in which the content of vinyl acetate is between 10% and 40%. This tie layer serves the function of preventing the transfer of the pressure sensitive adhesive to the surface which is to be protected even under critical conditions such as temperatures of 80° centigrade or exposure to UV rays.

### CROSS-REFERENCE TO RELATED APPLICATION

This application claims priority of Mexico patent application number MX/a/2007/007521 filed Jun. 15, 2007, currently pending, the entire contents of which are incorporated herein by reference.

### BACKGROUND

The present invention, referred to as a multi-layered, self-adhesive, protective film, is an innovation in the formulation and production of the protective film resulting in an improvement over similar products in current use. Multi-layered, self-adhesive, protective films are well known in the industry and used to protect numerous surfaces including glass, metal, wood, etc. These films are made of one or more layers of polyolefin. In the case of multilayer films, they typically have a base layer formed of polyethylene or polypropylene, which is formed either by extrusion with dies or blown extrusion. The base layer may also contain additives to modify the surface of the film. These films may have a second layer of polyethylene or polypropylene with low steric regularity that contains pigment. They may also have an interior layer of polyolefin such as polypropylene or polyethylene on which the adhesive is deposited. The adhesive may be applied by well-known techniques using rollers or by coextrusion. When adhesive, whether in solid or liquid form, is applied by means of rollers, the surface of the polyolefin that receives the adhesive should have its surface energy increased by means of a process such as corona treatment. Existing protective films are made with polyolefins polymerized with catalysts of the Ziegler-Natta type, although it is also possible to use polymers catalyzed by means of metallocenes or other new generation catalysts.

There exist many types of multi-layer films. Some of the patents or applications for patents demonstrate the advantages of using polyolefins and or copolymers of vinyl acetate and ethylene which include: US4551380; US2001014384; JP2004090379; JP11235795; JP 2000177073; JP2005178216; JP2004345308; JP2006289867; AU6576786; CA2053898; EP1300238; O0153079; WO9415787. Nevertheless, none of these refer to the specific materials used in the present invention and additionally, they are intended for different uses than the present invention.

The process for manufacturing film usually involves two steps in the process, utilizing adhesives of a solvent or water base, which by their nature have a negative impact on the environment.

### BRIEF SUMMARY OF THE INVENTION

The present invention refers to a multi-layered, self adhesive, protective film comprised of:
a base layer (A) made of a homopolymer or copolymer of polyethylene type C2 or C3;
a pressure sensitive adhesive layer (C) made of a copolymer of ethylene and vinyl acetate, with a vinyl acetate content between 45% and 90%;
the layer formed by A+C serves as a multi-layer, self-adhesive, protective film. Both layers, A+C are united by:
a tie layer (B) made of a polyolefin or a copolymer made of a base of ethylene and vinyl acetate which have been modified by the addition of maleic anhydride or a copolymer formed of ethylene and vinyl acetate with 10% to 40% vinyl acetate.

This tie layer has as its purpose the prevention of the transfer of the pressure-sensitive adhesive to the surface to be protected by forming a tight bond with the base layer.

The multi-layered, self-adhesive, protective film utilizes components which are not harmful to the environment, has better adherence between the layers to avoid marking the protected surface because of failure of the adhesion between the base layer and the adhesive layer under critical conditions such as temperatures in excess of 80° C. or exposure to UV rays.

The multi-layered, self-adhesive, protective film can be adjusted by varying the content of the pressure-sensitive adhesive layer to meet the needs of the specific application of the film.

### BRIEF DESCRIPTION OF THE DRAWINGS

A more complete understanding of the present invention may be had by reference to the following Detailed Description when taken in connection with the accompanying Drawings, wherein:

FIG. 1 is a schematic illustration of a first embodiment of the invention comprising three layers; and

FIG. 2 is a schematic illustration of a second embodiment of the invention comprising five layers.

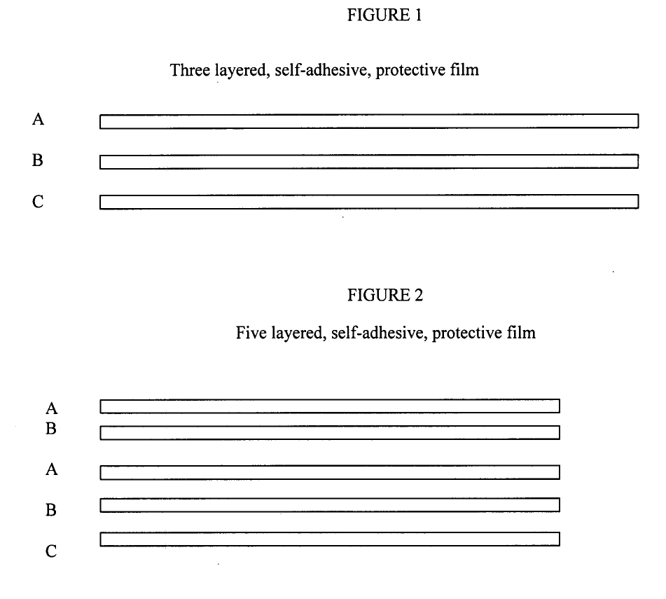

### DETAILED DESCRIPTION OF THE INVENTION

We have discovered that it is possible to manufacture a multi-layered, self-adhesive, protective film by a process of blown co-extrusion and also by means of co-extrusion with dies using a tie layer (B) which contains a polyolefin or a copolymer made of ethylene and vinyl acetates which have been modified by the addition of maleic anhydride, or a copolymer made of ethylene and vinyl acetate in which the content of vinyl acetate is between 10% and 40%.

The tie layer (B) allows the base layer (A) and the pressure sensitive adhesive layer (C) to react as a single highly cohesive unit under working conditions for the film.

The pressure sensitive adhesive layer (C) is composed of a copolymer made of ethylene and vinyl acetate with a content of vinyl acetate between 45% and 90%.

The tie layer (B) can also be made with a mix of olefin and a copolymer composed of ethylene and vinyl acetate with the content of vinyl acetate between 10% and 40%.

The multi-layered, self-adhesive, protective film is a film which has a permanent adhesiveness on one surface at ambient temperature and it firmly adheres to a great variety of surfaces.

The layers of the film preferably should be formed in the following manner:

Base layer (A):
comprised of a polyolefin such as a homopolymer or copolymer of polyethylene or a homopolymer or copolymer with or without additives. When additives are used, these serve to modify the surface of the plastic layer. In the case of a three layer film, the base layer may also contain a pigment. In the case of a five layer film, the pigment is added to the second or third layer.
   Tie layer (B):
contains a polyolefin or copolymer made of ethylene and vinyl acetate which have been modified by the addition of maleic anhydrite; or a copolymer made of ethylene and vinyl acetate with a content of vinyl acetate between 10% and 40%.
The tie layer can, but need not, be mixed with polyolefin to balance the mechanical properties of the film and to cover the function of adhering the various layers which comprise the film.
   Pressure sensitive adhesive layer (C):
made of a copolymer comprised of ethylene and vinyl acetate with a content of vinyl acetate between 45% and 90%, which may be mixed with polyolefin or a copolymer made of ethylene and vinyl acetate with a content of vinyl acetate between 10% and 40%, as is required to achieve the level of adhesion needed.

The preferred components for the invention are:
1) The polyolefin contained in the base layer can be any polymer of practical use in the fabrication of thermoplastic film. The polymers which are preferred are homopolymers and copolymers of propylene and homopolymers and copolymers of polyethylene. Other useful polymers include, but are not limited to, polyester, polyamides, etc. In the preferred polymer in the present invention, the polymer contained in the base layer should have a higher point of fusion than the principal polymer in the tie layer, although this is not necessary.

The homopolymers of propylene which are particularly useful in the fabrication of the base layer are those which have a melt flow that is between 0.5 to 10 g/10 min. (measured by the standard for polypropylene ASTM D 1238), with a melting point above 130° C. and with an isotacticity greater than 90% meso pentads (measured using C¹³ NMR).

Homopolymers of sindiotactic propylene can also be used for the base layer when they have a melt flow as described above for isotactic homopolymers.

The polypropylene copolymers include the following copolymers: propylene/ethylene in a ratio of 95-99.5%/5-0.5%, propylene/1 butene in a ratio of 50-99.5%/50-0.5%, propylene/1 pentene in a ratio of 50-99.5%/50-0.5%, propylene/1 hexene in a ratio of 50-99.5%/50-0.5%, as well as a propylene copolymer/4 methyl 1 pentene in a ratio of 50-99.5%/50-0.5%.

It is preferable that the polypropylenes and polyethylenes used in the base layer be previously polymerized using metalocen catalysts because it would result in a much narrower distribution of molecular weight and a more uniform composition.

The base layer may also be made of a polyethylene that has a melt flow of 0.5 to 10 g/10 min. according to ASTM D1238, a polydispersity Mw/Mn of 2 to 10, and a melting point from 90° to 140° C.
2. The tie layer should have one or more of the preferred polymers, such as low density polyethylene modified with maleic anhydride, low density lineal polyethylene modified with high density maleic anhydride, polyethylene modified with maleic anhydride, propylene modified with maleic anhydride. Other also preferred polymers for the tie layer are copolymers made with ethylene and vinyl acetate modified with maleic anhydride and copolymers made with ethylene and vinyl acetate in which the content of vinyl acetate is between 10% and 40% depending on the nature of the materials to be joined. When using polyolefins modified with maleic anhydride, they are to be mixed with homopolymers or copolymers of high or low density polyethylene, whether or not they are lineal. They may also be mixed with polypropylene. The percentages for the mixture are adjusted depending on the amount of adhesion between the layers of the material but also according to the level of maleic anhydride to modified polyolefin.
3. The pressure sensitive adhesive layer is composed of a copolymer made of ethylene and vinyl acetate.

The preferred polymers to serve as pressure sensitive adhesives are copolymers of ethylene and vinyl acetate in which the content of vinyl acetate is between 45% and 90%. The melt flow should be between 1 up to 8 g/10 min. (measured at 190° C.). The skeleton for this polymer is formed by methylene totally saturated with acetate groups. These skeletons give the polymers great resistance to weather, aging and chemical agents.

According to ISO 1629; 1995 (E) those copolymer skeletons are designated as EVM and correspond to the elastic part of the copolymer formed from ethylene and vinyl acetate (EVA).

The polyethylene contained in the preferred copolymer is crystalline due to the regularity of the structure of the molecular chain, the vinyl acetate molecules affect this regularity because of their great volume. For this reason, the preferred copolymer used in this layer does not reveal a crystalline structure, that is, it is amorphous. This characteristic of the preferred copolymer is what makes it extremely elastic (it does not require a plasticizer) and for this reason, it can form film of less than 5 microns with a high resistance to weather and chemical agents.

The copolymer used as the pressure sensitive adhesive has a glass transition temperature that tends to increase in conformity with the increase in the content of vinyl acetate and meets the requirement of Dahlquist and with the requirement of the window of elasticity of Chang to be classified as a Pressure Sensitive Adhesive.

The structure of the multi-layered, self-adhesive, protective film has an overall thickness between 12 and 125 microns:
The thickness of the base layer is between 30% and 95% of the total thickness.
The thickness of the tie layer constitutes between 5% and 40% of the total thickness.
The thickness of the pressure-sensitive adhesive layer constitutes between 1% and 30% of the total thickness.

Below, is an example of the process by blown extrusion for producing the film in the present invention.

The color of the multi-layered self-adhesive, protective film in the present invention can be clear, opaque or colored. Opacity is achieved by using a method which produces hollows, referred to in the industry as “cavitation.” The process of cavitation is achieved when a process of hollowing is incorporated in the polymer which results in disperse hollows incompatible with the polymer it will make opaque. The hollows may be produced by any method which does not degrade the material of which the film is made. These materials should have a higher fusion point than the polymer material of the layer in which they are incorporated. Such materials can be polyamides, polyesters, acrylic resins and polybuthylene terephthalate (PBT) and its quantity is from 2% up to 15% based on the weight of the layer which is to be cavitated. (See U.S. Pat. No. 4,377,616).

When a white finish on the film is desired, pigments of titanium bioxide are used.

To modify or improve the properties of the multi-layer, self-adhesive, protective film in this invention, additives may be added according to industry standards to one or more of the layers. The additives may include, but not by limitation:
Anti-blocking agents: silica, synthetic silicates, acrylics, derivatives of long chain fatty acids, silicon derivatives, etc.
Anti-friction agents: stearamide, silicon oil, silicon gum, euracamide, etc.
Anti-static agents: glycerin monostearate (GMS), long chain amine acids, etc.
Opacity agents: titanium bioxide

Below, is an example of the process by blown extrusion for producing the film in the present invention.

### EXAMPLE OF THE INVENTION

A trial run for producing the multi-layered, pressure-sensitive protective film with three layers was carried out. The film was produced using low density polyethylene as the material for the base layer. The tie layer uniting the pressure-sensitive adhesive with the polyethylene base layer was made of a copolymer composed of ethylene and vinyl acetate.

| Material | Melt flow | Density | Thickness of the layer |
|---|---|---|---|
| EVA | 6 g/10 min | 0.99 g/cm³ | 10 microns |
| (VA = 70%) | | | |
| adhesive layer | | | |
| Ethylene | 1.7 g/10 min | .094 g/cm³ | 10 microns |
| Vinyl Acetate | | | |
| (VA = 18%) | | | |
| tie layer | | | |
| LDPE | 1.0 g/10 min | 0.92 g/cm³ | 40 microns |

EVA = copolymer of ethylene and vinyl acetate
VA = content of vinyl acetate
LDPE = low density polyethylene

### Equipment Used

The tests were realized on the blown coextrusion lines in the laboratories of the Centro de Investigación de Química Aplicada de Saltillo (Center for Investigation of Applied Chemistry in Saltillo, Mexico).

| Type of extruder | 70F30D VLS | 80F30D VLS | 70F30D VLS |
|---|---|---|---|
| Diameter of the | 70 | 80 | 70 |
| screw (mm) | | | |
| Layer | central | internal | external |
| Thickness | 10 | 40 | 10 |
| (microns) | | | |
| Relation | 15 | 70 | 15 |
| Material | EVA (VA = 18%) | LDPE | EVA |
| | | | (VA = 70%) |

To improve the homogenization, each worm was equipped with a high shear device in the exit section. The flow of the merged mass from each extruder were united in a circular mandrel to form an annular flow in three layers.

| | | | |
|---|---|---|---|
| Diameter d d, a (mm) | 350 | Relation of blow BUR | 2.2 |
| Circumference u d, i (mm) | 1090.8 | Capture velocity (m/min) | 30 |
| Circumference u d, a (mm) | 1099.6 | | |
| Space between rims (mm) | 1.4 | | |
| Exit speed (m/min) | 14.7 | | |

Operating conditions for the extruders

| | EVA | | EVA |
|---|---|---|---|
| | (VA = 18%) | LDPE | (VA = 70%) |
| Zone 1 | 150° C. | 170° C. | 80° C. |
| Zone 2 | 150° C. | 165° C. | 90° C. |
| Zone 3 | 150° C. | 160° C. | 115° C. |
| Zone 4 | 155° C. | 165° C. | 120° C. |
| Sieve temperature | 150° C. | 165° C. | 130° C. |
| Clamp temperature | 150° C. | 165° C. | 130° C. |
| Die temperature | 160° C. | 160° C. | 160° C. |
| Merged mass pressure | 185 bars | 300 bars | 190 bars |

RESULTS:

| | 24 h at 25° C. | 24 h at 80° C. |
|---|---|---|
| Resistance to | 33 N/m | 93.5 N/m |
| pealing at 180° | | |
| on painted metal | | |

Note:
the removal of the film after aging for 24 hours at 80° C. and with prior conditioning at 25° C. does not leave a residue on the surface of the painted metal.

It is noted that as of the date of this application, the best method known to applicant for producing this invention is that set forth herein.

The manufacture of multi-layered protective films with an adhesive layer or coating are known and common in the industry. However, all known previous multi-layered protective film products are made in a two-step process, often involving substances which may be harmful to the environment and do not have the particular, desirable properties found in the present invention. The following elements of the invention described above are claimed as new and worthy of patent protection.

1. A multi-layered self-adhesive protective film characterized by the following composition:
a base layer comprising a material selected from the group consisting of C2 homopolymers, C3 homopolymers, C2 copolymers, and C3 copolymers
a pressure-sensitive adhesive layer comprising a copolymer composed of ethylene and vinyl acetate wherein the content of vinyl acetate is between 45% and 90%; and
a tie layer for securing the base layer to the pressure-sensitive adhesive layer comprising a material selected from the group consisting of polyolefins comprising ethylene and vinyl acetate which have been modified by the addition of maleic acid, copolymers comprising ethylene and vinyl acetate which have been modified by the addition of maleic acid, and copolymers of ethylene and vinyl acetate wherein the vinyl acetate content is between about 10% and about 40%.

2. The multi-layered self-adhesive protective film according to claim 1 wherein:
the tie layer permits the base layer and the pressure-sensitive adhesive layer to react as a single highly cohesive entity under the working conditions of the protective film.

3. The multi-layered self-adhesive protective film according to claim 1 wherein the base layer further includes a pigment.

4. The multi-layered self-adhesive protective film according to claim 1 wherein the tie layer further includes at least one additional polyolefin for balancing the mechanical properties of the film.

5. The multi-layered self-adhesive protective film according to claim 1 wherein the base layer comprises a homopolymer having a melt flow of between about 0.5 and about 10 g/10 min.

6. The multi-layered self-adhesive protective film according to claim 1 wherein the pressure sensitive adhesive layer has a melt flow of between about 1 and about 8 g/10 min.

7. The multi-layered self-adhesive protective film according to claim 1 wherein the total thickness of multi-layered self-adhesive protective film is between about 12 and about 125 microns.

8. The multi-layered self-adhesive protective film according to claim 7 wherein the thickness of the base layer comprises between about 30% and about 90% of the total thickness of the multi-layered self-adhesive protective film.

9. The multi-layered self-adhesive protective film according to claim 7 wherein the thickness of the tie layer comprises between about 5% and about 40% of the overall thickness of the multi-layered self-adhesive protective film.

10. The multi-layered self-adhesive protective film according to claim 7 wherein the thickness of the pressure-sensitive adhesive layer comprises between about 1% and about 30% of the overall thickness of the multi-layered self-adhesive protective film.

11. A multi-layered self-adhesive protective film characterized by the following composition:
a base layer comprising a material selected from the group consisting of C2 homopolymers, C3 homopolymers, C2 copolymers, and C3 copolymers
a pressure-sensitive adhesive layer comprising a copolymer composed of ethylene and vinyl acetate wherein the content of vinyl acetate is between 45% and 90%; and
a tie layer for securing the base layer to the pressure-sensitive adhesive layer comprising a material selected from the group consisting of low density polyethylene modified with maleic anhidride, low density lineal polyethylene modified with maleic anhidride, high density polyethylene modified with maleic anhidride, copolymers of ethylene and vinyl acetate modified with maleic anhidride, and copolymers comprising ethylene and vinyl acetate wherein the vinyl acetate content is between about 10% and about 40%.

12. The multi-layered self-adhesive protective film according to claim 11 wherein:
the tie layer permits the base layer and the pressure-sensitive adhesive layer to react as a single highly cohesive entity under the working conditions of the protective film.

13. The multi-layered self-adhesive protective film according to claim 11 wherein the base layer further includes a pigment.

14. The multi-layered self-adhesive protective film according to claim 11 wherein the tie layer further includes at least one additional polyolefin for balancing the mechanical properties of the film.

15. The multi-layered self-adhesive protective film according to claim 11 wherein the base layer comprises a homopolymer having a melt flow of between about 0.5 and about 10 g/10 min.

16. The multi-layered self-adhesive protective film according to claim 11 wherein the pressure sensitive adhesive layer has a melt flow of between about 1 and about 8 g/10 min.

17. The multi-layered self-adhesive protective film according to claim 11 wherein the total thickness of multi-layered self-adhesive protective film is between about 12 and about 125 microns.

18. The multi-layered self-adhesive protective film according to claim 11 wherein the thickness of the base layer comprises between about 30% and about 90% of the total thickness of the multi-layered self-adhesive protective film.

19. The multi-layered self-adhesive protective film according to claim 11 wherein the thickness of the tie layer comprises between about 5% and about 40% of the overall thickness of the multi-layered self-adhesive protective film.

20. The multi-layered self-adhesive protective film according to claim 11 wherein the thickness of the pressure-sensitive adhesive layer comprises between about 1% and about 30% of the overall thickness of the multi-layered self-adhesive protective film.
